(19) United States
(12) Patent Application Publication
(10) Pub. No.: US 2004/0080143 A1
(43) Pub. Date: Apr. 29, 2004

(54) Hand-pulled folding utility cart

(76) Inventor: Oriz Wickline Johnson, Cincinnati, OH (US)

Correspondence Address: Oriz W. Johnson, 7086 Butterwood Drive, Cincinnati, OH, 45241, US

(21) Appl. No.: 10/282,297

(22) Filed: Oct. 29, 2002

(51) Int. Cl. B62B 3/02

(52) U.S. Cl. 280/651

(57) ABSTRACT

A extremely lightweight hand-pull cart made of connected panels of leather-tough corrugated plastic sheet material primarily intended to assist the physically marginal to move groceries from car to kitchen, said cart having an extended pulling tongue, a very low center of gravity, commodious fabric-sided cargo compartment, a plurality of small roller-wheels and stair sliding-runners strategically affixed to underside of said cargo compartment which in unique interplay with said pulling tongue enables easier negotiation, both up and down, of stairs and stoops, lastly said cart to fold upon itself into a flat, lightweight, compact package for hand carrying, or for virtual abuse-proof storage in car trunk till needed.

### CROSS REFERENCES TO RELATED APPLICATIONS

None

### FEDERALLY SPONSORED RESEARCH

None

### MICROFICHE APPENDIX

None

### BACKGROUND OF THE INVENTION

1. Field of the Invention

Class 280/47.11/.24/.26/.34/638/639/651

2. Discussion of the Prior Art

The inventor respectfully submits that absent motorized apparatus, there is no prior art noted by the inventor, admittedly a layman searcher, dedicated to the stair climbing function of the present invention, inasmuch as the vast preponderance of all prior art relative to personal utility handcarts involves push-type devices having the storage compartment generally elevated well above fairly large wheels for easier access to the cargo and for easy rolling The popular push type carts are virtually impossible to push up stairs and must be pulled up. However even pulling a push-type up is still difficult because the push type carts are not designed for this purpose. While pull-type carts, on the other hand, have an easier time of it, they too are designed primarily for outdoors, used in the woods, camping grounds and beaches where irregular or soft terrain favor a pull cart with voluminous wide-base wheels, and have little or no design criteria focused on negotiating stairs. Inasmuch as in both cases, the user must stand close to the cart, the cart generally interferes with the user's feet as she or he moves up the stairs backward. Additionally, large wheels present a problem negotiating each and every stair step.

As a clear distinction, the type of service the present invention is intended to meet is primarily carrying groceries and similar consumer purchases on paved paths between parked cars and the interior of homes, enabling very small roller-wheels. Virtually all said paths unfortunately having a flight of stairs, or at the very least, a one, two or three step stoop to contend with. The present invention sacrifices easy rolling, off-road or irregular terrain advantages, to secure, instead, an advantage in negotiating these inevitable stairs.

Secondly those push or pull carts that are foldable or collapsible are only partially so, generally having a substantial, cumbersome, and rigid metal frame to contend with. The proposed invention has no heavy metal frame, in fact, it has no frame.

### OBJECTIVES AND ADVANTAGES

The first objective of the invention is to recognize and address the fact that in the United States as well as several other countries of the world, the population is growing older. In this country thanks to modern medicine in large measure, people are living much longer, leading active lives although not always easily or devoid of pain. These facts led to the development of the invention.

Many women still semi-active, live solitary lives with no men about. They must still go about the business of living and providing for themselves, sometimes in considerable pain of rheumatism, arthritis, osteoporosis and similar afflictions of older age. For instance, the older women may be active enough to drive to the grocery store, bring groceries to their car in a grocery cart but when arriving home must unload the groceries to the kitchen without benefit of a grocery cart, or cart of any nature. Several painful trips may be involved. Additionally there may be many painfully heavy loads of various descriptions other than groceries which necessarily need to be moved about the house, and if the house has two or more floors, negotiating stairs is even more painful. If one is able bodied or devoid of pain, this invention may hold little interest, but if indeed not free of pain, it may be a veritable godsend.

In another, and lighter, for instance, young moderns who are certainly strong and able, frequently live in apartments generally hundreds of feet from their parking area. A trunk full of groceries involves several inconvenient trips, generally up one or more flights of stairs. Young moderns have other, more interesting, things to do.

Yet another for instance, the mighty mall has assumed a significant role in American family life, with most necessaries other than groceries bought there, hundreds of feet from the parked car. And malls do not provide carts, as do grocery stores.

These examples, and myriad more, show vivid need for a commodious, stair-friendly personal handcart to facilitate the demands of modern living. Moreover the need requires that the handcart be light, sturdy, safe of tipping and preferably collapsible to easily store in small apartments or carry in car trunks for use when and as required.

### SUMMARY OF THE INVENTION

The present solution, while exceedingly austere and simple of design, meets all the above requirements and more. It is indeed commodious, capable of as much volume and weight as most grocery carts, and sturdily constructed of heavy-gauge, virtually indestructible polypropylene corrugated plastic sheet. The low-slung, ground-hugging design is so stable it is virtually untipable. The construction features dedicated to easier stairway negotiation, the cause celebre of the invention, is firstly, this squat, low-center-of-gravity geometry employing small diameter roller-wheels that enable the cart to literally hug the stairs, belly to belly, as it slides its way up or down the stairs. Secondly, an extended tongue panel and forward sloping front panel enable the user to stand several steps up ahead of the cargo compartment thus eliminating the troublesome, sometimes dangerous, tangling with the user's feet. Thirdly, the sloping front panel has friction-reducing runners facing the stairs to help slide the nose of the cart up onto the first step, after which the cart rides on its bottom slide runners. Fourthly, the use of the tiny unobtrusive bottom roller-wheels which will not catch on each stair ledge on the way up, and which enable smooth transition of the weight of the cargo load from wheels to adjacent slide runners, and which controllably roll off each step when descending stairs as explained below. And fifthly, the placement of several long, narrow, slick-plastic slide runners under the bottom of the cart adjacent to the small roller-wheels which first act as levers in the stair descent mode, but more important, insure almost imperceptible surface contact, only a couple of square millimeters, between the slide runners and leading edge of the stairs being negotiated. The effect is virtually zero friction drag, and inasmuch as stairs generally proceed upwards at about 45 degrees, the load being pulled up the stairs slides up effortlessly at effectively half the weight. Should the user tire on the way up, a single flexing of the tongue panel will sit the back of the cargo compartment squarely down on a step in a stable resting position, the fall-out panel helping to retain the cargo inside the compartment while in this sloping resting position. This flexing technique is discussed below.

Descending the stairs with a full load, as not infrequently happens, as for instance, taking laundry to the basement, or if one lives in a below-grade apartment, is made effortless through the interplay of the tongue panel and the geometry of the cart. Once the descent of the cart is started, the user, standing well up from the descending cart by reason of the extended pulling tongue panel, can cause the cart to slowly descend in front of her or him one step at a time by easily flexing the tongue panel forward and back thus flexing the front panel of the cargo compartment which in turn flexes the bottom panel with its slide runners to lever the back edge of the cargo compartment, now leading the descent down to stairs, to roll off one step and drop to the next, one step at a time, and at the speed desired. The speed is totally controlled as the back edge of the descending cart comes to a stable stop on each step and will not drop further until the tongue panel is intentionally flexed. If desired, the tongue panel can be held in its flexed position enabling the cart to slide down any number of steps without stopping. Continuing, the small back roller-wheels are not in contact with the stair step surface in the step-by-step descent until the rig is flexed, which does bring the back roller-wheels, levered by the stiff bottom slide runners, into a position to roll off the step thus lowering the back panel of the cart down to the next step, and so on. The slight backward, ten-degree slope of the back panel insures that the cart sits on this sloping panel in the resting position, but can be easily levered to slide off the step when desired. For an aged or marginal user, this easily controlled descent removes anxiety or risk of a loaded bag plunging headlong down the stairs unrestricted. As Archimedes reputedly remarked, “Give me a long enough lever and a fulcrum and I will move the world.” The flexing panels of the cart act as both levers and fulcrums to each other in this ingenious geometry and the quickly mastered flexing motion of the tongue panel, requiring generally only the stiffened couple of fingers of the same hand holding the tongue panel hand hold, makes even a heavily loaded cart walk down the stairs virtually effortlessly.

As a further matter of use convenience, lifting hand holes are located in the upper margin of the front and back panels of the cargo compartment such that the compartment if not overly heavy, can be lifted not unlike a laundry hamper, which in fact it may frequently be. The pulling tongue panel in this case may be simply folded back horizontally onto the top of the cargo. It should be noted that the flutes run longitudinally making the light corrugated panels more than sufficiently stiff for this lifting, or any other, duty.

This exceedingly tough corrugated, muchly air-filled panel construction and mesh fabric sides weighs in at only three pounds, super light for hand-carrying in its collapsed condition, perhaps into a mall. Said collapsed condition is easily accomplished by folding the panels in on themselves into a neat, virtually indestructible flat package only some 18 inches square and three inches thick for storage in a closet or car trunk. This package can be thrown into the trunk of a car and piled on with both abandon and impunity, fearing no damage. The 18 inches square can be easily 12 or 24 inches on a side depending on a lesser or larger model chosen.

### DESCRIPTION OF THE DRAWINGS

FIG 1: A plan view of the chassis showing strategic score creases between panels, also showing roller-wheel and hand holes.

FIG. 2: A cabinet oblique perspective view of the exploded pull cart showing the configured body panels, fabric sides and roller-wheel-slide assembly.

FIG. 3: A cabinet oblique of the roller-wheel-slide assembly.

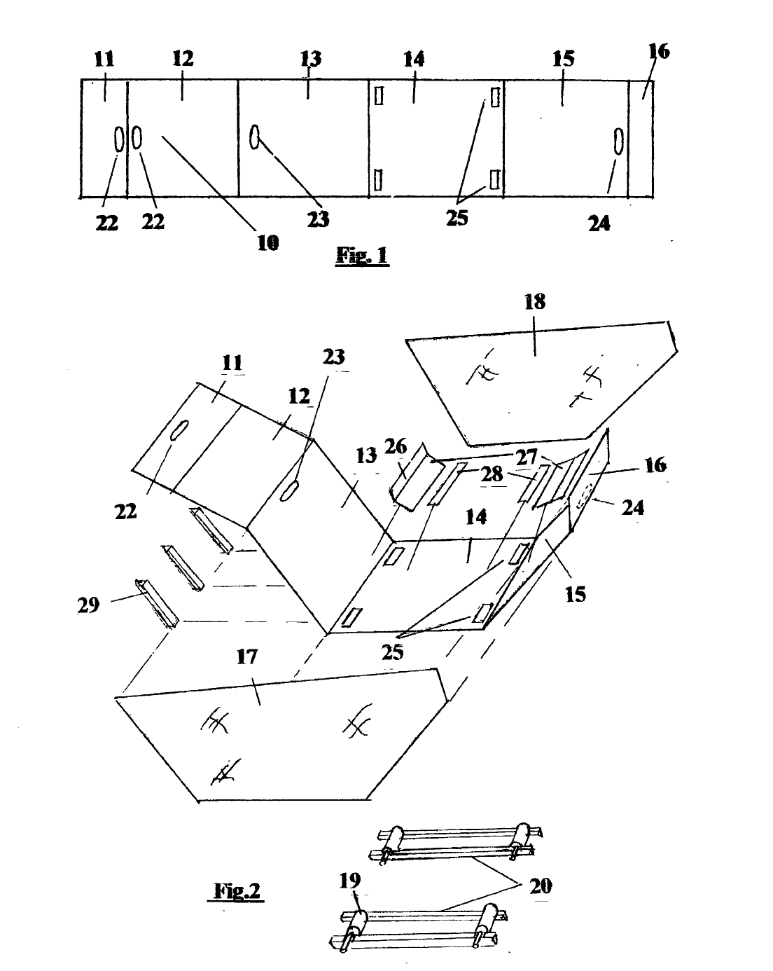

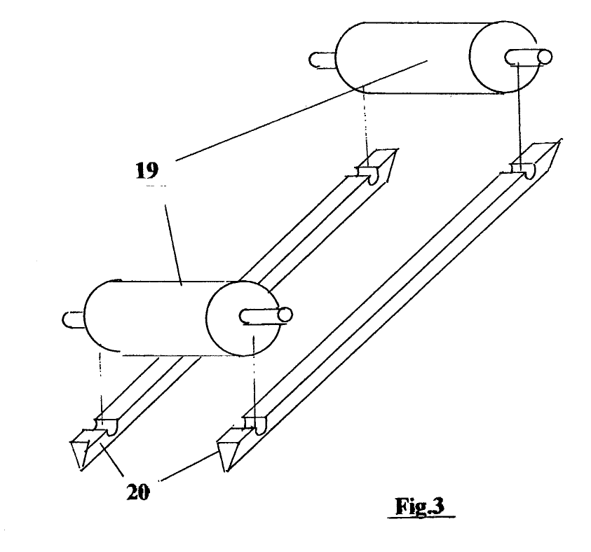

### LIST OF REFERENCE NUMBERS IN THE DRAWINGS

| | |
|---|---|
| Elongated rectangular chassis | 10 |
| Stiffness panel | 11 |
| Tongue panel | 12 |
| Front panel | 13 |
| Bottom panel | 14 |
| Back panel | 15 |
| Fall-out panel | 16 |
| Left fabric siding | 17 |
| Right fabric siding | 18 |
| Roller-wheels | 19 |
| Bottom slide runners | 20 |
| None | 21 |
| Pull hand hole | 22 |
| Front lift handhold | 23 |
| Rear lift handhold | 24 |
| Roller-wheel well-holes | 25 |
| Guard fixed-section | 26 |
| Guard flexing-section | 27 |
| Guard slide-travel stop | 28 |
| Front slide runners | 29 |

### DESCRIPTION OF THE INVENTION

The preferred embodiment of the invention comprises an elongated rectangular sheet of stiff 4 mm thick corrugated polypropylene sheet 79 inches long and some 16 inches wide having the corrugated flutes run longitudinally. The aforementioned sheet is die-cut with hand, and roller-wheel holes and is scored to bend from the first end into essentially 6, 16, 19, 19, 16, & 3-inch deep panels. The 6″ stiffness panel 11 at the first end is folded over at the shared score crease and fixedly attached flatly to the surface of the adjacent 16″ tongue panel 12 to add desired stiffness at that point without resorting to needless extra thickness throughout the rest of the chassis. The hand hole of panel 11 aligns with hand hole in tongue panel 12 to form double-thickness pulling hand hole 22. With the tongue panel horizontal, the remaining contiguous panels of the chassis are then bent at each of the respective score creases up or down to assume the essentially trapezium shape matching the shape and size of fabric side panels 17 and 18, to wit, front panel 13 is flexed forward some 30 degrees from vertical, bottom panel 14 is horizontal, back panel 15 is flexed back 10 degrees from vertical and fall-out panel 16 is flexed forward 45 degrees from vertical. Vertical front slide runners 29 are fixedly attached to outside bottom half of sloping front panel 13. The edges of fabric sides 17 and 18 are fixedly attached to the corresponding edges of the chassis to form an open-topped cargo compartment having fabric sides. The purpose of fall-out panel 16 is to prevent cargo from tumbling out the back of the cargo compartment when the cart is progressing up or down stairs. Combination roller-wheel-slide-runner assemblies 19-20, long, narrow, hard plastic, runners notched at each end to accommodate small roller-wheel axles, are fixedly attached in the longitudinal axis to the bottom of the roller-wheel base panel 14. To achieve an even lower profile, the upper half of the small roller-wheels 19 protrude up through roller-wheel well holes 25 into the cargo compartment above and are protected from binding with cargo by flexing roller-wheel guards 26-27 made of the same stiff, scored-to-bend, polypropylene sheet material. Fixed section 26 of said guards is fixedly attached to sheets 13 and 15 such that the flexible flap portion of the guards 27 extend down at essentially 45 degrees to slidably rest on the top surface of roller-wheel base panel 14, creating a stiff protective cover over the protruding roller wheels. Guard travel stops 28 fixedly attached to top surface of roller-wheel base panel 14 at a predetermined position to stop the slide travel of guard flaps 27 thus holding panels 13 and 15 in proper inclined vertical juxtaposition to roller-wheel base panel 14, and maintaining sufficient tension on fabric side panels 17 and 18 to insure both fabric sides are taut when the pull cart is in its open condition. To close the cart, the front and back cargo panels are manually spread slightly further open to momentarily free the guard flaps from the stops, the flaps raised to slide unrestricted over the stops, the guards fold onto themselves at their scored crease and enable the front and back cargo panels to fold inward down onto the bottom panel. Before this final folding step, the tongue panel is first folded into the cargo compartment flat against the front panel. The fabric sides may be carefully folded into the confines of the package, or not, as desired. Available as an accessory is a zippered top, not shown, for the cargo compartment for use when used as a mall shopping cart to dissuade snatch-and-run thieves.

Ramifications and Scope of the Invention

While tie above descriptions of my preferred embodiment contains many specificity's, these should not be construed as limitation on the scope of the invention, but rather as an exemplification of one preferred embodiment thereof. Many other variations of virtually every concept or component defined are possible, accordingly the scope of the invention should be determined not by the embodiment illustrated but by the appended claims and their legal equivalents. Some, but by no means all, of these alternate embodiments follow.

Other Embodiments

The embodiment of the hand-pulled cart as defined above is much the preferred embodiment for many direct and indirect reasons. There are however several other embodiments which are quite functionally valid. Some of these variations are briefly discussed below. These and all others of similar ilk are believed to be encompassed in the claims of this application.

Firstly, the trapezium-like, open-topped, geometric shape of the cargo compartment could be changed in shape, even to round, triangular, oval or other exotic but less functional configuration.

The elongated pulling tongue panel could be shortened or eliminated, but not without penalizing the stair climbing function.

Roller-wheels could be instead, small housed balls or, for that matter, large conventional roller-wheels.

The stiff material specifically selected, to wit, 4 mm corrugated polypropylene plastic sheets, could as well be sheet metal, plywood, stiffened canvas, corrugated cardboard, fiberglass, carbon-fiber or virtually any other version of polymer plastic flat sheet material. Moreover, the sheets could be semi-stiff instead of stiff.

Instead of bendable scored creases in a single elongated panel, the panels could be separate, connected by hinges, connecting rings, bendable fabric glued to each panel or any of a number of equivalent flexible joining or hinging techniques.

Instead of elongated rectangular, the panels could be square, oval or other exotic shapes, again connected by the above joining techniques.

Instead of flat panels, the cart could be made of a series of connected wire frame “panels” of suitable configuration with a canvass or similar fabric or flexible material slipped onto the frames as a “sock”.

The fabric cargo compartment sides could be thin stiff sheet material having accordion bends for folding.

The slide runners could have an almost infinite cross section configurations and lengths, but the preferred is the fewest and simplest. The underside of the bottom could be dimpled or otherwise imprinted with protruding patterns or be covered with a multitude of small ball-roller-wheels which would perform the function of the sliding runners.

I claim:

1: A hand-pulled folding utility cart having a flexibly-articulated, multiple stiff-panel chassis, said chassis panels forming in series a stiff pulling-tongue panel and collapsible cargo compartment, said utility cart having means for negotiating stairs, said articulated panels foldable flat upon each other.

2: A hand-pulled cart as recited in claim 1, wherein said chassis 10 comprising an elongated rectangular sheet of stiff material, cross-scored at pre-determined points to freely flex up to 360 degrees in vertical plane at each score, creating a plurality of in-line contiguously articulated flat panels of predetermined lengths 11-16 along the longitudinal axis of said sheet.

3: A hand-pulled cart as recited in claim 1 wherein said collapsible cargo compartment comprising three contiguous articulated flat panels, third, fourth and fifth respectively from first end of said elongated sheet, folded at aforementioned cross-score lines, said third panel 13 and fifth panel 15 being flexed semi-vertically upward, said fourth panel 14 forming horizontal cargo compartment bottom.

4: A hand-pulled cart as recited in claim 1, wherein said stiff pulling tongue comprising second panel 12 from first end of said flat elongated sheet of stiff material flexibly articulated to top of following semi-vertical third panel 13, said stiff pulling tongue flexed horizontal at cross-score line and having a centered handhold hole 22 near forward edge.

5: A hand-pulled cart as recited in claim 4 wherein said pulling tongue panel further having stiffener comprising first panel from first end of said stiff material 11 folded 180 degrees at contiguous cross-score line and fixedly attached to surface of pulling tongue panel 12, panel 11 having hand hole aligning with hand hole in panel 12 to form double-strength hand hole 22 at leading edge of said pulling tongue panel.

6: A hand-pulled cart as recited in claim 3, wherein said two semi-vertical flat panels 13 & 15 having lifting handhold holes 23 & 24 centered near top of each panel.

7: A hand-pulled cart as recited in claim 3, wherein cargo compartment bottom panel 14 having a plurality of roller-wheel well-holes.

8: A hand-pulled cart as recited in claim 3, wherein said collapsible cargo compartment further comprising fore and aft roller-wheel guards.

9: A hand-pulled cart as recited in claim 8, wherein each of said guards made of stiff sheet material, scored to bend into two flat horizontal sections, first of two said sections, fixed-sections 26, fixedly attached to near bottom inside surface of the two vertical flat panels 13 & 15 of cargo compartment; bottom edges of second said sections, flexing-sections 27 extending over roller-wheel well holes 25 and slidably resting against top surface of bottom panel 14 of said cargo compartment, said second sections resting, when stopped, at a predetermined distance over said roller-wheel well holes.

10: A hand-pulled cart as recited in claim 3 wherein said collapsible cargo space further comprising guard slide-travel stops 28 fixedly attached to top surface of bottom panel 14.

11: A hand-pulled cart as recited in claim 3, wherein top of rear semi-vertical panel 15 further having articulated fall-out top panel 16 flexed forward at cross-score line.

12: A hand-pulled cart as recited in claim 1 wherein said collapsible cargo space having fabric material sides.

13: A hand-pulled cart as recited in claim 12, wherein said collapsible cargo space fabric sides comprising sheets of fabric material fixedly attached to and spanning exterior side edges of the two semi-vertical panels 13 & 15, fall-out panel 16 and horizontal bottom panel 14 creating two fabric sides 17 & 18 to the cargo space.

14: A hand-pulled cart as recited in claim 1 wherein said means for negotiating stairs comprising in combination said flexibly articulated pulling tongue 12 and a plurality of small diameter rotatable rollers 19 fixedly attached to underside of bottom panel 14 of said cargo compartment, said rollers aligned in direction of longitudinal axis of said bottom panel, top portion of said roller-wheels protruding up into said cargo compartment through said roller wheel well holes 25 and under wheel guard flexing sections 27.

15: A hand-pulled cart as recited in claim 1 wherein said means for negotiating stairs further comprising in combination said flexibly articulated pulling tongue 12 and a plurality of elongated slide runners 20 fixedly attached to underside of bottom panel 14 of said cargo compartment, said runners aligned in direction of longitudinal axis of said bottom panel, said slide runners being narrow ridges of hard material protruding downward below the underside of said compartment bottom panel.

16: A hand-pulled cart as recited in claim 1, wherein said means for negotiating stairs further comprising in combination said flexible articulated pulling tongue 12 and a plurality of front slide runners 29 fixedly attached to outside surface of forward panel 13, said runners aligned vertically in direction of longitudinal axis of said forward panel, said slide runners being narrow ridges of hard material protruding outward of said outside forward surface.
